(19) United States
(12) Patent Application Publication
(10) Pub. No.: US 2020/0033224 A1
(43) Pub. Date: Jan. 30, 2020

(54) ON VEHICLE COMPRESSED AIR SYSTEM LEAK DETECTION

(71) Applicant: Cummins Inc., Columbus, IN (US)

(72) Inventor: Travis L. WALTERS, Columbus, IN (US)

(73) Assignee: Cummins Inc., Columbus, IN (US)

(21) Appl. No.: 16/497,848

(22) PCT Filed: Mar. 26, 2018
(86) PCT No.: PCT/US2018/024282

§ 371 Date: Sep. 26, 2019

Related U.S. Application Data
(60) Provisional application No. 62/479,913, filed on Mar. 31, 2017.

(51) Int. Cl. G01M 3/26; B60C 23/16; B60T 13/66; B60T 17/02; B60T 17/22

(52) U.S. Cl. CPC G01M 3/26; B60C 23/16; G01M 3/002; B60T 17/02; B60T 17/221; B60T 13/662

(57) ABSTRACT

A system for detecting a compressed air system leak. The system includes a first air tank, a second air tank, a pressure sensor, and a controller communicatively coupled to at least one of the pressure sensor. The controller is structured to determine an identifiable event including a requested air use or an unrequested air use, determine a leak rate associated with the identifiable event, compare the leak rate to a leak threshold, and generate a command structured to indicate a compressed air system leak responsive to the leak rate exceeding the leak threshold.

### CROSS-REFERENCE TO RELATED APPLICATIONS

The present application claims priority to and benefit of U.S. Provisional Patent Application No. 62/479,913, filed Mar. 31, 2017 and entitled “On Vehicle Compressed Air System Leak Detection,” the entire disclosure of which is incorporated herein by reference.

### TECHNICAL FIELD

The present disclosure relates generally to compressed air devices and systems for use with internal combustion engines.

### BACKGROUND

A compressed air system of a vehicle may be used for brake applications. The vehicle can still operate with a certain amount of a leak in the compressed air system. However the leak causes the vehicle engine powered compressor to pump more frequently to keep the compressed air system charged to an acceptable level. When the engine powered air compressor increases its pumping frequency, more parasitic load is placed on the engine which in turn requires that the engine burn more fuel to operate. Accordingly, a need exists for detecting a compressed air system leak and alerting a vehicle operator when the leak develops.

### SUMMARY

Embodiments described herein relate generally to systems and methods for detecting a compressed air system leak of a vehicle. The method includes determining an identifiable event associated with a compressed air system of an operable vehicle,

determining a leak rate associated with the identifiable event, comparing the leak rate to a leak threshold, and generating a command structured to indicate a compressed air system leak responsive to the leak rate exceeding the leak threshold.

One implementation relates to an apparatus. The apparatus includes a compression management circuit configured to be coupled to a compressed air system, the compression management circuit structured to determine an identifiable event associated with the compressed air system, determine a leak rate associated with the identifiable event, compare the leak rate to a leak threshold, and generate a command structured to indicate a compressed air system leak responsive to the leak rate exceeding the leak threshold.

One implementation relates to a system. The system includes a first air tank, a second air tank, a pressure sensor, and a controller communicatively coupled to at least one of the pressure sensor, the first air tank, or the second air tank. The controller is structured to: determine an identifiable event comprising a requested air use or an unrequested air use, the identifiable event associated with a compressed air system, determine a leak rate associated with the identifiable event, compare the leak rate to a leak threshold, and generate a command structured to indicate a compressed air system leak responsive to the leak rate exceeding the leak threshold.

Still another implement relates to a method for detecting a compressed air system leak of a vehicle. The method includes determining an identifiable event associated with a compressed air system of an operable vehicle. A leak rate associated with the identifiable event is determined. The leak rate is compared to a leak threshold, and a command structured to indicate a compressed air system leak is generated responsive to the leak rate exceeding the leak threshold.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic illustration of a vehicle including a compressed air system, according to an embodiment.

FIG. 2 is a schematic diagram of an example compressed air system that may be used with the systems of FIG. 1.

FIG. 3 is a schematic diagram of an example controller that may be used with the systems of FIG. 1.

FIG. 4 is a schematic diagram of a flowchart of a method for detecting a compressed air system leak, according to an example embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Referring to the Figures generally, the various embodiments disclosed herein relate generally to a system and method for detecting a compressed air system leak of a vehicle. According to the present disclosure, the system includes a first air tank, a second air tank, a pressure sensor, and a controller. The controller is communicatively coupled to at least one of the pressure sensor, the first air tank, or the second air tank. The controller is structured to determine an identifiable event comprising a requested air use or an unrequested air use. The identifiable event is associated with a compressed air system. The controller is further structured to determine a leak rate associated with the identifiable event, compare the leak rate to a leak threshold, and generate a command structured to indicate a compressed air system leak responsive to the leak rate exceeding the leak threshold. The command is structured to alert an operator of the compressed air system leak.

Various embodiments of the systems and methods described herein for detecting a compressed air system leak of a vehicle may provide benefits that include, for example (1) monitoring the compressed air system continuously; (2) reducing fuel consumption and service brake use; (3) minimizing the parasitic load on the engine of the vehicle; and (4) alerting a driver when a leak develops.

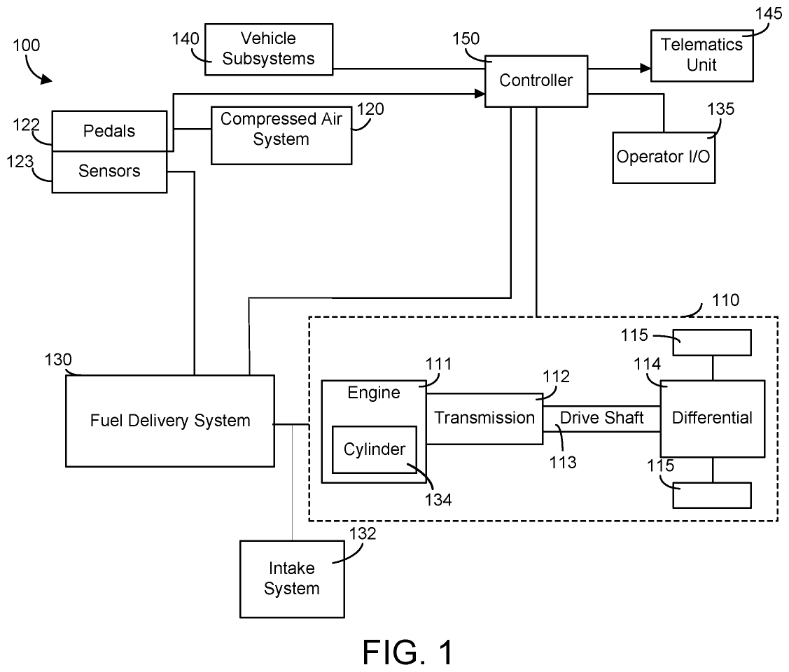

FIG. 1 is a schematic block diagram of an example vehicle 100 having an example compressed air system 120 according to an example embodiment. The vehicle 100 may be an on-road or off-road vehicle including, but not limited to, trucks (e.g., semi-trucks), buses, cars, boats, vans, airplanes, or any other type of vehicle. The vehicle 100 is shown to generally include a controller 150 communicably and operatively coupled to a powertrain system 110, a compressed air system 120, an operator input/output (I/O) device 135, one or more additional vehicle subsystems 140, and a telematics unit 145. It should be understood that the vehicle 100 may include additional, less, and/or different components/systems than depicted in FIG. 1, such that the principles, methods, systems, apparatuses, processes, and the like of the present disclosure are intended to be applicable with any other vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

The powertrain system 110 facilitates power transfer from the engine 111 to power the vehicle 100. The powertrain system 110 includes an engine 111 operably coupled to a transmission 112, a drive shaft 113, and a differential 114, where the differential 114 transfers power output from the engine 111 to the final drive (shown as wheels 115) to propel the vehicle 100. As a brief overview and in this configuration, the engine 111 is structured as an internal combustion engine that receives a chemical energy input (e.g., a fuel such as natural gas, gasoline, ethanol, or diesel) from the fuel delivery system 130, and combusts the fuel to generate mechanical energy, in the form of a rotating crankshaft. The transmission 112 receives the rotating crankshaft and manipulates the speed of the crankshaft (e.g., the engine speed, which is usually expressed in revolutions-per-minute (RPM)) to effect a desired drive shaft 113 speed. The rotating drive shaft 113 is received by a differential 114, which provides the rotation energy of the drive shaft 113 to the final drive 115. The final drive 115 then propels or moves the vehicle 100.

In the example depicted, the engine 111 is structured as an internal combustion engine. In particular, the engine 111 may be structured as a multi-fuel engine, wherein more than one fuel may be used (e.g., combusted) by the engine 111. However, this depiction is not meant to be limiting as the present disclosure also contemplates that the same or similar principles and technologies may also be used with other air compression technologies.

Similarly, the transmission 112 may be structured as any type of transmission, such as a continuous variable transmission, a manual transmission, an automatic transmission, an automatic-manual transmission, a dual clutch transmission, etc. Accordingly, as transmissions vary from geared to continuous configurations (e.g., continuous variable transmission), the transmission can include a variety of settings (e.g., gears, for a geared transmission) that affect different output speeds based on the engine speed. Like the engine 111 and the transmission 112, the drive shaft 113, differential 114, and final drive 115 may be structured in any configuration dependent on the application (e.g., the final drive 115 is structured as wheels in an automotive application and a propeller in an airplane application). Further, the drive shaft 113 may be structured as a one-piece, two-piece, and a slip-in-tube driveshaft based on the application.

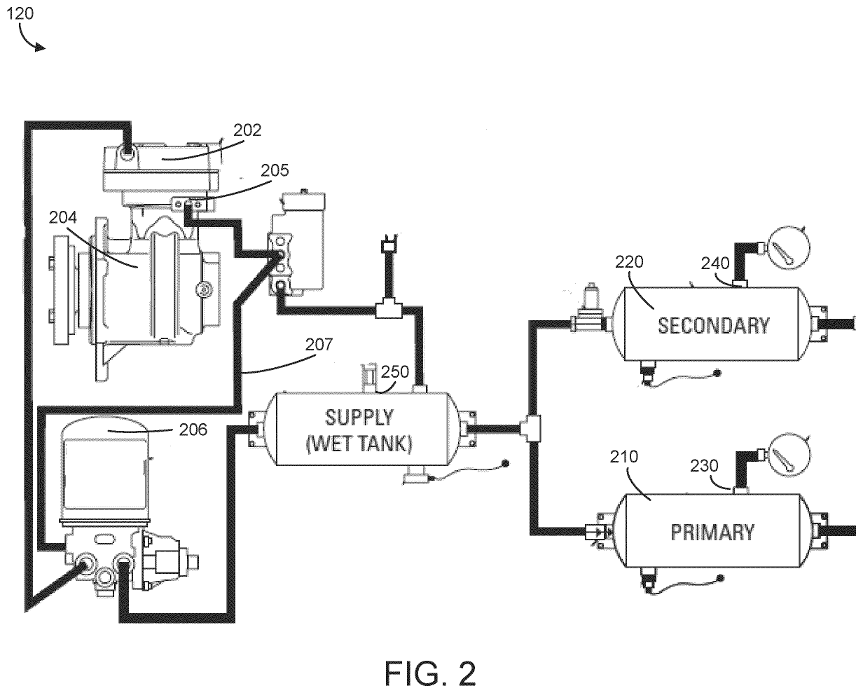

As shown, the vehicle 100 includes the compressed air system 120. The compressed air system 120 (illustrated in FIG. 2) functions to compress the air and provide the compressed air to various systems and components of the vehicle 100. The compressed air system 120 includes, a compressor 202, a dryer 206, a first air tank 210, a second air tank 220, a pressure sensor 230, 240, supply tank 250, and a controller 204. Although a plurality of sensors 205, 230, 240 and air tanks 210, 220 are depicted, the compressed air system 120 may include a single sensor and/or air tank. In some example configurations, the compressed air system 120 is structured to control the brakes (e.g., pneumatic brakes, hydraulic brakes, service brakes, parking brakes, drum brakes, disc brakes, etc.) of the vehicle 100. In some configurations, the compressed air system 120 may be connected to an air intake assembly (not shown). The compressed air is provided to a system (e.g., a pneumatic brake system) connected to the engine 111. In some embodiments, compressed air applied to or otherwise pressed on a piston (not shown) may be used to provide pressure to a brake pad. In turn, the pressure applied to the brake pad prevents the vehicle 100 from moving. Other types of components and systems using compressed air from compressed air system 120 may be used in alternate embodiments. In some embodiments, the compressed air system 120 may be structured to adjust the suspension of a vehicle (e.g., adjust the suspension of a truck). In other embodiments, the compressed air system 120 may be structured to control the tire inflation system, the air suspension of the driver and/or passenger seats, the horn, or a combination thereof of the vehicle 100.

In some configurations, the compressed air system 120 includes the first air tank 210 (e.g., the primary air tank), the second air tank 220 (e.g., the secondary air tank), or a combination thereof. The air tank (e.g., the first air tank 210, the second air tank 220, and/or the supply tank 250) may receive compressed air from a compressor 202. The compressor 202 may be powered by the engine 111. A governor 207 may manage the governed pressure (e.g., the maximum and/or minimum pressure) of each respective air tank. In an example embodiment, when the brake pedal is depressed (e.g., a vehicle operator steps on the brake pedal, treadle valve, etc.), air from the air tank (e.g., the first air tank 210 and/or the second air tank 220) may flow into a cylinder such that a piston is pushed down the cylinder to provide pressure to the brake pad which prevents the vehicle 100 from moving.

The compressed air system 120 may include a supply tank 250 (e.g., a wet tank). The supply tank 250 may be structured to receive, house, or otherwise store compressed air. The compressed air may be treated by a cooling coil, oil separator, air dryer (e.g., the air dryer 206), pressure regulator, or a combination thereof. The compressed air may then be stored in the supply tank 250 and, in turn, distributed or otherwise provided to the front and rear brakes, parking brakes, auxiliary air system, etc.

With reference back to FIG. 1, the vehicle 100 may include a throttle system (e.g., a throttle system including an intake manifold throttle) depending on the engine system utilized. The throttle system generally includes a throttle valve (e.g., a ball valve, a butterfly valve, a globe valve, or a plug valve), which is operatively and communicably coupled to a pedal 122 and one or more sensors 123. The throttle valve is structured to selectively control the amount of intake air provided to the engine 111. Because the type of engine 111 may vary from application-to-application, the type of throttle valve may also vary with all such possibilities and configurations falling within the spirit and scope of the present disclosure.

The pedal 122 may be structured as any type of brake device included with a vehicle (e.g., a floor-based pedal, a brake lever, etc.). Further, the sensors 123 may include any type of sensors included with the vehicle 100. For example, the sensors 123 may include a mass air flow rate sensor that acquires data indicative of an intake amount of air flowing to the engine 111, a pedal position sensor that acquires data indicative of a depression amount of the pedal (e.g., a potentiometer), an ambient air temperature sensor, a pressure sensor, a fuel temperature sensor, a charge air temperature sensor, a coolant temperature and pressure sensor, a fuel pressure sensor, an injection pump speed sensor, and the like.

As depicted, the vehicle 100 includes the operator I/O device 135. The operator I/O device 135 enables an operator of the vehicle to communicate with the vehicle 100 and the controller 150. Analogously, the I/O device 135 enables the vehicle or controller 150 to communicate with the operator. For example, the operator I/O device 135 may include, but is not limited to an interactive display (e.g., a touchscreen, etc.) having one or more buttons/input devices, haptic feedback devices, a pedal, a clutch pedal, a shifter for the transmission, a cruise control input setting, a navigation input setting, etc. Via the input/output device 135, the operator can receive information (e.g., alerts, notifications, etc.) associated with the compressed air system 120, receive various fuel economy characteristics, emissions characteristic, etc. Further, via the I/O device 135, the controller 150 can also provide commands/instructions/information to the operator (or a passenger).

As also shown, the vehicle 100 includes one or more vehicle subsystems 140. The various vehicle subsystems 140 may generally include one or more sensors (e.g., a pressure sensor, speed sensor, torque sensor, ambient pressure sensor, temperature sensor attached or otherwise communicatively coupled to the compressed air system 120, etc.), as well as any subsystem that may be included with a vehicle. The one or more sensors (e.g., the pressure sensors) may be structured for dynamic engagement. For example, the sensors may be add-on pressure sensors. In other embodiments, the pressure sensor may be structured for static engagement. For example, the sensors may be static pressure sensors.

The vehicle 100 is also shown to include a telematics unit 145. The telematics unit 145 may be structured as any type of telematics control unit. Accordingly, the telematics unit 145 may include, but is not limited to, a location positioning system (e.g., global positioning system) to track the location of the vehicle (e.g., latitude and longitude data, elevation data, etc.) or to identify predetermined boundaries, one or more memory devices for storing the tracked data, one or more electronic processing units for processing the tracked data, and a communications interface for facilitating the exchange of data between the telematics unit 145 and one or more remote devices (e.g., a provider/manufacturer of the telematics device, etc.). In this regard, the communications interface may be structured as any type of mobile communications interface or protocol including, but not limited to, Wi-Fi, WiMax, Internet, Radio, Bluetooth, Zigbee, satellite, radio, Cellular, GSM, GPRS, LTE, etc.

The telematics unit 145 may also include a communications interface for communicating with the controller 150 of the vehicle 100. The communication interface for communicating with the controller 150 may include any type and number of wired and wireless protocols (e.g., any standard under IEEE 802, etc.). For example, a wired connection may include a serial cable, a fiber optic cable, an SAE J1939 bus, a CATS cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information, and/or data between the controller 150 and the telematics unit 145. In other embodiments, a local area network (LAN), a wide area network (WAN), or an external computer (for example, through the Internet using an Internet Service Provider) may provide, facilitate, and support communication between the telematics unit 145 and the controller 150. All such variations are intended to fall within the spirit and scope of the present disclosure.

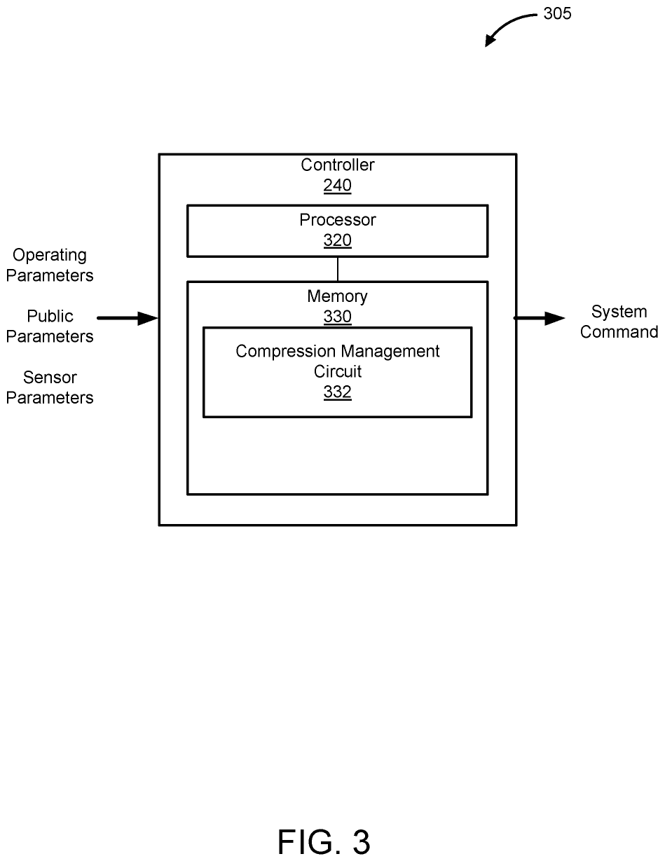

The controller 150 is communicably and operatively coupled to the powertrain system 110, the compressed air system 120, the fuel delivery system 130, the operator I/O device 135, the one or more vehicle subsystems 140, and the telematics unit 145. Communication between and among the components may be via any number of wired or wireless connections (e.g., any standard under IEEE 802, etc.). For example, a wired connection may include a serial cable, a fiber optic cable, an SAE J1939 bus, a CATS cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information, and/or data. Because the controller 150 is communicably coupled to the systems and components in the vehicle 100 of FIG. 1, the controller 150 is structured to receive data (e.g., instructions, commands, signals, values, etc.) from one or more of the components shown in FIG. 1. As will be appreciated, the functioning of the controller 204 of FIG. 3 may be similar to that of the controller 150. For the sake of brevity, additional description of the controller 204 is omitted.

It should also be understood that other or additional operating parameters to detect a compressed air system leak may be used. For example, additional parameters may include engine speed, characteristics of the compressed air system 120 (e.g., timing, quantity, rate, etc.), characteristics of any glow plugs or heater elements, crankshaft position, brake and clutch position/operation, battery voltage, temperatures (e.g., air, oil, fuel, coolant, etc.), pressures (e.g., intake air, fuel, oil, etc.), and so on.

According to the present disclosure, the compressed air system 120 may detect a compressed air system leak. Advantageously, the detection of the compressed air system leak may result in resolving the leak rapidly which reduces fuel costs and improves fuel efficiency of the vehicle 100.

Further, as the components of FIG. 1 are shown to be embodied in a vehicle 100, the controller (e.g., the controller 150, 204) may be structured as, include, or be communicably and operatively coupled to at least one of an engine controller, gaseous fuel controller, compressed air system controller, etc. The function and structure of the controller is described herein with reference to FIG. 3.

With the above description in mind, referring now to FIG. 3, an example structure of a control circuitry 305 including the controller 240 is shown according to one embodiment. In particular embodiments, the controller 150 shown in FIG. 1 may be substantially similar in structure and function to the controller 204. As shown, the controller 204 includes a processing circuit including a processor 320 and a memory 330. The processor 320 may be implemented as one or more general-purpose processor, an ASIC, one or more field programmable gate arrays (FPGAs), a digital signal processor (DSP), a group of processing components, or other suitable electronic processing components. In some embodiments, the one or more processors may be shared by multiple circuits (e.g., the compression management circuit 332 or any other circuit of the controller 204 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory 330 may take the form of one or more memory devices (e.g., RAM, ROM, Flash Memory, hard disk storage, etc.) that may store data and/or computer code for facilitating the various processes described herein. Thus, the memory 330 may be communicably connected to the processor 320 and provide computer code or instructions to the processor 320 for executing the processes described in regard to the controllers herein. Moreover, the memory 330 may be or include tangible, non-transient volatile memory or non-volatile memory. Accordingly, the memory 330 may include database components, object code components, script components, or any other type of information structure for supporting the various activities and information structures described herein.

The memory 330 may include various circuits for completing at least some of the activities described herein. More particularly, the memory 330 includes the compression management circuit 332 which is structured to facilitate the detection of a compressed air system leak. While the memory 330 of the controller 204 depicted is shown to include the compression management circuit 332 it should be understood that the controller 204 and memory 330 may include any number of circuits for completing the functions described herein. For example, the activities of multiple circuits may be combined as a single circuit, additional circuits with additional functionality may be included, etc. Further, it should be understood that the controller 204 may control other activity beyond the scope of the present disclosure, such as the control of other vehicle systems. In this regard, the controller 204 may be embodied as an electronic control unit (ECU), proportional integrated controller (PID), etc. included with a vehicle or included with an existing ECU, such as a compressed air system control unit and any other vehicle control unit (e.g., powertrain control circuit, engine control circuit, etc.). All such structural configurations of the controller 204 are intended to fall within the spirit and scope of the present disclosure. Although a single controller 204 is shown, some example configurations may include a plurality of controllers. The controller 204 may be communicatively coupled to one or more components and/or systems of the vehicle 100 via the compression management circuit 332. For example, the controller 204 may be communicatively coupled to at least one of the pressure sensor 205, 230, 240, the first air tank 210, or the second air tank 220 of the vehicle 100.

In one configuration, the compression management circuit 332 is embodied as machine or computer-readable media (e.g., stored in the memory 330) that is executable by a processor, such as the processor 320. As described herein and amongst other uses, the machine-readable media (e.g., the memory 330) facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). Thus, the computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, compression management circuit 332 is embodied as a hardware unit such as an electronic control unit. As such, compression management circuit 332 may be embodied as one or more circuitry component including, but not limited to, processing circuitry, network interfaces, peripheral devices, input devices, output devices, sensors, etc. In some embodiments, compression management circuit 332 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, compression management circuit 332 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

Thus, compression management circuit 332 may also include programmable hardware devices such as field programmable gate arrays, programmable array logic, programmable logic devices or the like. In this regard, compression management circuit 332 may include one or more memory devices for storing instructions that are executable by the processor(s) of compression management circuit 332. The one or more memory devices and processor(s) may have the same definition as provided below with respect to the memory 330 and the processor 320.

In the example shown, the controller 204 includes the processor 320 and the memory 330. The processor 320 and the memory 330 to execute or implement the instructions, commands, and/or control processes described herein with respect compression management circuit 332. Thus, the depicted configuration represents the aforementioned arrangement where compression management circuit 332 is embodied as a machine or computer-readable media. However, as mentioned above, this illustration is not meant to be limiting as the present disclosure contemplates other embodiments such as the aforementioned embodiment compression management circuit 332 may be configured as a hardware unit. All such combinations and variations are intended to fall within the scope of the present disclosure.

The compression management circuit 332 is structured to determine an identifiable event associated with the compressed air system 120. The compressed air system 120 may be associated with an operable vehicle (e.g., a vehicle which is powered-on) or an inoperable vehicle (e.g., a vehicle which is powered-off). In some configurations, the identifiable event may include a requested air use (e.g., an event requiring a desired use of compressed air in a vehicle such as the vehicle 100). For example, a requested air use may take the form of a brake event such as a force applied to a brake pedal that results in slowing or causing a vehicle (e.g., the vehicle 100) to come to a stop. In another example, a requested air use may take the form of a suspension event such as adjusting the height of a vehicle (e.g., a kneeling bus, lowing a vehicle when a particular gear such as park is selected using the compressed air from the compressed air system 120). In other examples, a requested air use may take the form of suspension event such as opening a door of a vehicle or a driver adjusting the height of a seat in a vehicle using the compressed air from the compressed air system 120. In other configurations, the identifiable event may include an unrequested air use (e.g., an event by which there is an undesired use of air that is indicative of an air leak from the compressed air system 120). For example, a leaking compressed air system associated with a malfunctioning vehicle air compressor 202. The compressed air system leak may be included in, for example, a trailer that may be picked up by a semi-truck. In turn, the fuel economy of the truck and trailer may be lowered.

The compression management circuit 332 is further structured to monitor the first and second air tanks 210, 220 of the compressed air system 120. In this regard, the compression management circuit 332 is structured to receive one or more parameters associated with the compressed air system 120. The one or more parameters may include at least one of engine operating parameters, public parameters (e.g., the SAE J1939 public parameters corresponding to information on the vehicle or one or more components thereof, for example, a vehicle VIN number, wheel speed, engine rpm, etc.), or sensor parameters (e.g., analog sensor parameters). The public parameters (e.g., public data) may be transmitted or otherwise provided to a private data broadcast rate. The public parameters may be received at a display (e.g., a dashboard or LCD of an information console)or a data logging system installed on the vehicle 100 (e.g., installed on a truck). In some examples, the compression management circuit 332 may receive the operating parameters from the vehicle 100. For example, when an operator applies a force to the brake pedal, the compression management circuit 332 receives operating parameters provided by the switch from the brake. In turn, the compression management circuit 332 determines that the brake event is an identifiable event (e.g., a requested air use) based on the one or more parameters and/or the value ranges of the one or more parameters received by the compression management circuit 332.

As described above, the identifiable event may include an unrequested air use such as, but not limited to, a compressed air system leak associated with a vehicle speed above a predetermined speed. Given that, the compression management circuit 332 monitors the air compressor 202 duty cycle change of the first and second air tanks 210, 220. The compression management circuit 332 may determine that the governor line pressure is at a predetermined line value. In some embodiments, when the governor line pressure is below 20 psi, the compressor 202 is on. Alternatively or additionally, when the governor line pressure is above 20 psi, the compressor 202 is off. In further embodiments, the compression management circuit 332 may calculate the duty cycle of the compressor 202. The compressor 202 on time may be divided by compressor 202 total time and multiplied by 100 to calculate the duty cycle of the compressor 202. In some embodiments, the compression management circuit 332 may programmatically calculate the duty cycle of the compressor 202. In other embodiments, the compression management circuit 332 may receive or otherwise obtain the duty cycle of the compressor 202 from the memory 330.

The compression management circuit 332 is structured to receive, via a sensor 123 (e.g., the pressure sensor of the first air tank 210 and/or the second air tank 220), data indicative of the pressure of each respective air tank. In still another embodiment, the compression management circuit 332 may include machine-readable media stored by the memory and executable by the processor, wherein the machine-readable media facilitates performance of certain operations to receive values indicative of the pressure of each respective air tank. For example, the machine-readable media may provide an instruction (e.g., command, etc.) to a sensor operatively coupled to the air tank, the compressed air system 120, and/or any other system or component of the vehicle 100 to monitor and acquire data indicative of the air pressure. In this regard, the machine-readable media may include programmable logic that defines the frequency of acquisition of the pressure data. If a sensor 123 (e.g., the pressure sensor of the first air tank 210 and/or the second air tank 220) indicates a change in the pressure of each respective air tank, the compression management circuit 332 determines whether a leak value (e.g., a leak amount, sample amount, etc.) provided by the pressure sensor is greater than a sample threshold. If the leak value is not greater than the sample threshold, the identified event may not be further diagnosed. If the leak value is greater than the sample threshold, the leak rate associated with the identifiable event is determined. The leak value, leak rate, and any associated parameters described herein may be stored in memory (e.g., memory 330) by the compression management circuit 332. In various embodiments, the compression management circuit 332 may be configured to detect a leak of less than 4 pounds per square inch in the compressed air system 120.

The compression management circuit 332 is structured to determine a leak rate associated with the identified event. The leak rate is determined based on condition data, temperature data, pressure data, or a combination thereof. The leak rate may be determined according to a change in pressure divided by change in time. The compression management circuit 332 may compare the leak rate to a leak threshold. The leak threshold includes the minimum value at which air may leak from the compressed air system. The leak threshold may be in the range of a calibrateable floor to a calibrateable ceiling. For example, the leak threshold may be set at a leak threshold for a first compressed air system architecture while a second compressed air system architecture may have a different leak threshold. As will be appreciated, the range corresponding to the leak threshold (e.g., the calibrateable floor to the calibrateable ceiling) may vary based, at least in part, on the vehicle architecture for operability according to various conditions. A compressed air system (e.g., the compressed air system 120) may therefore be precalibrated to determine the specific leak threshold thereof, and provided to the compression management circuit 332. In some example embodiments, for leak rates at and/or above the leak threshold or outside of the range corresponding to the leak threshold a command (e.g., a fault code corresponding to a compressed air system indicative of an air leak) may be generated as described herein.

The compression management circuit 332 is structured to generate a command that indicates a compressed air system leak responsive to the leak rate exceeding the leak threshold. For example, if the compression management circuit 332 determines that the leak rate exceeds the leak threshold, the command corresponding to a raised fault code is generated. The raised fault code indicates that there is an air leak in the compressed air system. If the compression management circuit 332 determines that the leak rate does not meet or exceed the leak threshold, the command corresponding to a low fault code is generated and the compression management circuit 332 returns to determining an identifiable event associated with the compressed air system 120. The low fault code indicates that the identifiable event does not require service of the compressed air system 120.

The command (e.g., the raised fault code) is structured to alert an operator of the compressed air system leak. In this regard, the compression management circuit 332 is structured to output a notification (e.g., a notification signal) of the compressed air system leak based on the command generated. The compression management circuit 332 may output the notification via an onboard diagnostic system, a display associated with a vehicle, or a combination thereof Alternatively or additionally, the compression management circuit 332 may output the notification to a remote user device (not shown) via a network configured for wireless communication such as WiFi. In some embodiments, the compression management circuit 332 may output the notification to the telematics unit 145. In turn, the telematics unit 145 may provide the notification to a user or operator of the vehicle 100 via a vehicle management interface (e.g., a user interface or mobile application configured to manage one or more vehicles, such as a fleet of vehicles).

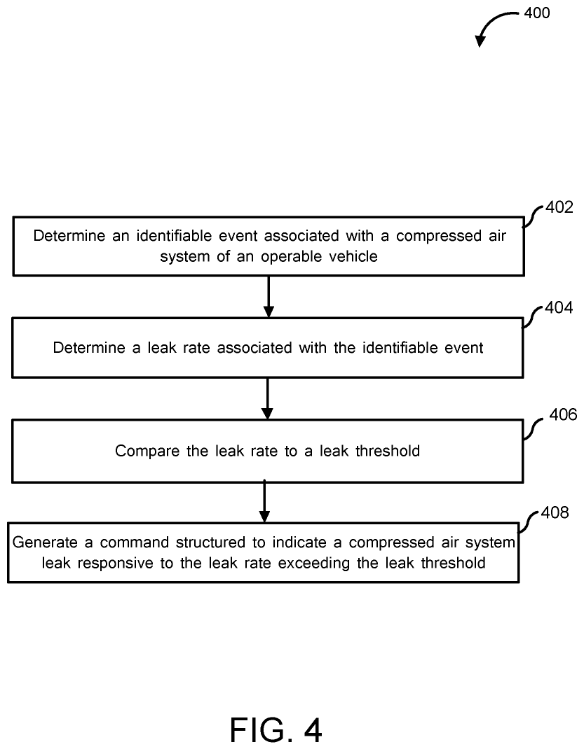

Referring now to FIG. 4, a flowchart of a method for detecting a compressed air system leak is shown, according to one embodiment via the circuitry described herein with reference to FIGS. 1-3. At process 402, an identifiable event associated with the compressed air system is detected, for example, by the controller 150. In one embodiment, the identifiable event may include a requested air use (e.g., a desired use of compressed air in a vehicle such as the vehicle 100). In other configurations, the identifiable event may include an unrequested air use (e.g., an undesired use of air that is indicative of an air leak). For example, an unrequested air use may be a leaking compressed air system associated with a malfunctioning vehicle air compressor (e.g., the vehicle air compressor 202).

At process 404, the controller (e.g., the controller 150, 204) determines a leak rate associated with the identifiable event. If the sensor 123 (e.g., a pressure sensor of the first air tank 210 and/or the second air tank 220) indicates a change in the pressure of the air tank, the controller determines whether a leak value (e.g., a leak amount) provided by the pressure sensor is greater than a sample threshold. If the leak value is not greater than the sample threshold, the identified event may not be further diagnosed and the process returns to 402. If the leak value is greater than the sample threshold, the leak rate associated with the identifiable event is determined. The leak rate is determined based on condition data, temperature data, pressure data, or a combination thereof.

The controller may compare the leak rate to a leak threshold, at 406. The leak threshold may be in the range of a calibrateable floor to a calibrateable ceiling. If the leak rate is not at and/or above the leak threshold, a command indicative of an air leak may not be generated. The process may then return to 402. If the leak rate is at and/or above the leak threshold or outside of the range corresponding to the leak threshold, a command indicative of an air leak may be generated, at 408.

The controller generates a command structured to indicate a compressed air system leak responsive to the leak rate exceeding the leak threshold, at 408. The command alerts an operator of the compressed air system leak. The controller may output the notification via an onboard diagnostic system, a display associated with a vehicle, or a combination thereof. For example, the command may be configured to activate or turn ON a malfunction indicator lamp (MIL), which may be configured to indicate to a user (e.g., an operator of a vehicle including the compresses air system), that a leak is present in the compressed air system. Alternatively or additionally, the controller may output the notification to the telematics unit 145 which may provide the notification to a user or operator via a vehicle management interface configured to manage a fleet of vehicles.

The schematic flow chart diagrams and method schematic diagrams described above are generally set forth as logical flow chart diagrams. As such, the depicted order and labeled steps are indicative of representative embodiments. Other steps, orderings and methods may be conceived that are equivalent in function, logic, or effect to one or more steps, or portions thereof, of the methods illustrated in the schematic diagrams.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Many of the functional units described in this specification have been labeled as circuits, in order to more particularly emphasize their implementation independence. For example, a circuit may be implemented as a hardware circuit comprising custom VLSI circuits or gate arrays, off-the-shelf semiconductors such as logic chips, transistors, or other discrete components. A circuit may also be implemented in programmable hardware devices such as field programmable gate arrays, programmable array logic, programmable logic devices or the like.

Circuits may also be implemented in machine-readable medium for execution by various types of processors. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit.

Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network. Where a circuit or portions of a circuit are implemented in machine-readable medium (or computer-readable medium), the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a computer or entirely on the computer or server. In the latter scenario, the computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As used herein, the term “proximate” may be used to refer to the position of a component or system in relation to one or more other components or systems such that the components may contact each other or may be near each other.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus, comprising:
a compression management circuit structured to:
determine an identifiable event associated with a compressed air system;
determine a leak rate associated with the identifiable event;
compare the leak rate to a leak threshold; and
generate a command structured to indicate a compressed air system leak responsive to the leak rate exceeding the leak threshold.

2. The apparatus of claim 1, wherein the compression management circuit is further structured to monitor, via a pressure sensor, pressure associated with a first air tank and a second air tank of the compressed air system.

3. The apparatus of claim 2, wherein the pressure sensor comprises at least one of a pressure sensor structured for dynamic engagement or a pressure sensor structured for static engagement.

4. The apparatus of claim 1, wherein the compression management circuit is further structured to receive one or more parameters associated with the compressed air system, and wherein the identifiable event is determined based on the one or more parameters.

5. The apparatus of claim 4, wherein the one or more parameters comprises at least one of engine operating parameters, public parameters, or sensor parameters.

6. The apparatus of claim 1, wherein the identifiable event comprises a requested air use or an unrequested air use.

7. The apparatus of claim 6, wherein the requested air use comprises at least one of a brake event, kneel event, or door engagement event and the unrequested air use comprises the compressed air system leak.

8. The apparatus of claim 1, wherein the compressed air system is associated with an operable vehicle or an inoperable vehicle.

9. A compressed air system, comprising:
a first air tank;
a second air tank;
a pressure sensor; and
a controller communicatively coupled to at least one of the pressure sensor, the first air tank, or the second air tank, the controller structured to:
determine an identifiable event comprising a requested air use or an unrequested air use, the identifiable event associated with a compressed air system;
determine a leak rate associated with the identifiable event;
compare the leak rate to a leak threshold; and
generate a command structured to indicate a compressed air system leak responsive to the leak rate exceeding the leak threshold.

10. The system of claim 9, wherein the command is structured to alert an operator of the compressed air system leak.

11. The system of claim 9, wherein the controller is further structured to receive one or more parameters associated with the compressed air system, the one or more parameters comprising at least one of engine operating parameters, public parameters, or sensor parameters.

12. The system of claim 11, wherein the identifiable event is determined based on the one or more parameters.

13. The system of claim 9, wherein the leak rate is determined based on condition data, temperature data, pressure data, or a combination thereof.

14. The system of claim 9, wherein the compressed air system is associated with an operable vehicle or an inoperable vehicle.

15. The system of claim 9, wherein the command is structured to output a notification of the compressed air system leak, the notification output via an onboard diagnostic system, a display associated with a vehicle, or a combination thereof.

16. A method for detecting a compressed air system leak of a vehicle, the method comprising:
determining an identifiable event associated with a compressed air system of an operable vehicle;
determining a leak rate associated with the identifiable event;
comparing the leak rate to a leak threshold; and
generating a command structured to indicate a compressed air system leak responsive to the leak rate exceeding the leak threshold.

17. The method of claim 16, further comprising monitoring first and second air tanks of the compressed air system.

18. The method of claim 16, further comprising receiving one or more parameters associated with the compressed air system, wherein the identifiable event is determined based on the one or more parameters, and wherein the one or more parameters comprise at least one of engine operating parameters, public parameters, or sensor parameters.

19. The method of claim 16, wherein the command is structured to alert an operator of the compressed air system leak.

20. The method of claim 16, wherein the leak rate is associated with a compressed air system leak less of than 4 pounds square inch.

21. The method of claim 16, wherein the identifiable event comprises a requested air use or an unrequested air use.
